(19) United States
(12) Patent Application Publication
(10) Pub. No.: US 2023/0205504 A1
(43) Pub. Date: Jun. 29, 2023

(54) MANAGING INSTALLATION OF APPLICATIONS ON COMPUTING DEVICES

(71) Applicant: Google LLC, Mountain View, CA (US)

(72) Inventors: Anuj Goyal, Mountain View, CA (US); Caitlin Kelly Phillips, Montreal (CA); Parastoo Geranmayeh, Montreal (CA); Chloé Calvarin, Montreal (CA); Zhechen Min, Montreal (CA); William Larsen, Mountain View, CA (US); Yi Ren, Oakland, CA (US)

(21) Appl. No.: 18/053,127

(22) Filed: Nov. 7, 2022

Related U.S. Application Data
(60) Provisional application No. 63/266,141, filed on Dec. 29, 2021.

(51) Int. Cl. G06F 8/61; G06F 3/0484

(52) U.S. Cl. CPC G06F 8/61; G06F 3/0484

(57) ABSTRACT

According to an aspect, a method for requesting installation of applications includes rendering information of an application store platform in a user interface of a first application executing on a computing device associated with an organization, rendering a UI control of the application store platform on the user interface, where the UI control provides an option to request installation of a second application provided by the application store platform, and transmitting, in response to selection of the option to request installation, a request to install the second application to a computing device associated with an administrator of the organization.

### CROSS-REFERENCE TO RELATED APPLICATION

This application claims priority to U.S. Provisional Patent Application No. 63/266,141, filed on Dec. 29, 2021, entitled “MANAGING INSTALLATION OF APPLICATIONS ON COMPUTING DEVICES”, the disclosure of which is incorporated by reference herein in its entirety.

### BACKGROUND

An administrator of an organization may allow some applications to be installed on computing devices associated with the organization and may block some applications to be installed on the computing associated with the organization. A user may request that a particular application be added to an allow list, but, in some examples, the request process may involve sending an email to the administrator, where the administrator may manually add the requested application to the list and then notify the user. However, this largely manual process may be relatively time consuming, complex, and resource intensive especially in a large company, in which an administrator may receive multiple requests for a wide variety of different applications and may be required to maintain different allow/block lists for different organizational units.

### SUMMARY

This disclosure relates to a management system that enables an administrator to allow users request installation of applications, provided by an application store platform, on managed devices. For example, the management system may enable a user's managed computing device to request installation of an application provided by an application store platform, where the installation request is aggregated with other pending requests for the same application, and sent, in real-time (or near real-time), to the administrator's computing device. The administrator can allow, block, or automatically install (e.g., force install) the applications that users request.

The application store platform may communicate with an application management unit of the management system to determine a status of an application offered by the application store platform, and, depending on the status, a UI control of the application store platform can be modified. For example, the management system may implement a communication protocol between the application store platform and the application management unit in which the UI control(s) of the application store platform can be selectively modified to generate an installation request, permit installation of the application on the computing device, or prevent the installation of the application on the computing device.

According to an aspect, a method for requesting installation of applications includes rendering information of an application store platform in a user interface of a first application executing on a computing device associated with an organization, rendering a UI control of the application store platform on the user interface, where the UI control provides an option to request installation of a second application provided by the application store platform, and transmitting, in response to selection of the option to request installation, a request to install the second application to a computing device associated with an administrator of the organization.

According to some aspects, the method may include one or more of the following features (or any combination thereof). The method may include determining a status condition of the second application and modifying the UI control based on the status condition. Modifying the UI control may include changing at least one of an action of the UI control or information displayed by the UI control. The modified UI control may provide an option to initiate installation of the second application. The method may include initiating, in response to selection of the option to initiate installation, installation of the second application on the computing device associated with the organization. The modified UI control may provide information that indicates that the request to install the second application is denied. The modified UI control provides information that indicates that the request to install the second application is pending. The method may include receiving configuration data for the UI control and modifying the UI control according to the configuration data. The method may include storing application management data for managing the computing device associated with the organization, where the application management data includes an application request setting. The method may include rendering, in response to the application request setting being enabled, the UI control in a first configuration, the UI control in the first configuration providing the option to request installation of the second application, and rendering, in response to the application request setting being disabled, the UI control in a second configuration, the UI control in the second configuration provides an option to initiate installation of the second application on the computing device associated with the organization. The method may include rendering a notification on a display of the computing device associated with the organization, where the notification indicates whether the request to install the second application is approved or denied. The first application may be a web browser. The first application may be an application store application executable by an operating system of the computing device associated with the organization.

According to an aspect, an apparatus includes at least one processor and a non-transitory computer-readable medium storing executable instructions that when executed by the at least one processor cause the at least one processor to render information of an application store platform in a user interface of a first application executing on a computing device associated with an organization, the computing device being associated with an application request setting, render, in response to the application request setting being enabled, a user interface (UI) control of the application store platform in a first configuration on the user interface, the UI control in the first configuration providing an option to request installation of a second application provided by the application store platform, and transmit, in response to selection of the option to request installation, a request to install the second application to a computing device associated with an administrator of the organization.

According to some aspects, the executable instructions include instructions that when executed by the at least one processor cause the at least one processor to render, in response to the application request setting being disabled, the UI control in a second configuration, the UI control in the second configuration providing an option to initiate installation of the second application on the computing device associated with the computing device. The executable instructions include instructions that when executed by the at least one processor cause the at least one processor to render, in response to the application request setting being enabled, the UI control in a second configuration, the UI control in the second configuration displaying information that indicates that the request to install the second application is denied. The executable instructions include instructions that when executed by the at least one processor cause the at least one processor to render, in response to the application request setting being enabled, the UI control in a second configuration, the UI control in the second configuration displaying information that indicates that the request to install the second application is pending. The executable instructions include instructions that when executed by the at least one processor cause the at least one processor to receive installation data in response to the request to install being approved, the installation data configured to cause the computing device associated with the organization to install the second application. The executable instructions include instructions that when executed by the at least one processor cause the at least one processor to receive configuration data for the UI control and render the UI control in the first configuration according to the configuration data. The second application may be an extension to the first application. The first application may be an application store application.

According to an aspect, a non-transitory computer-readable medium storing executable instructions that when executed by at least one processor causes the at least one processor to execute operations. The operations include render information of an application store platform in a user interface of a web browser executing on a computing device associated with an organization, render a UI control of the application store platform on the user interface, the UI control providing an option to request installation of an application provided by the application store platform, and transmit, in response to selection of the option to request installation, a request to install the application to a computing device associated with an administrator of the organization.

According to some aspects, the operations include storing application management data for managing the computing device associated with the organization, the application management data including an application request setting associated with the web browser, rendering, in response to the application request setting being enabled, the UI control in a first configuration, the UI control in the first configuration providing the option to request installation of the application, and rendering, in response to the application request setting being disabled, the UI control in a second configuration, the UI control in the second configuration providing an option to initiate installation of the application on the computing device associated with the organization. The operations may include detecting a request to display the information of the application store platform, receiving configuration data for the UI control, and modifying the UI control according to the configuration data. The request to install the application includes an application identifier of the application and a source identifier that identifies a source of the request to install the application. The application may be a web application executable by the web browser.

According to an aspect, an apparatus includes at least one processor and a non-transitory computer-readable medium storing executable instructions that when executed by the at least one processor cause the at least one processor to render a user interface of an administrative console application on a display of a computing device of an administrator associated with an organization, display an installation request on the user interface, the installation request being a request to install an application provided by an application store platform on a computing device associated with the organization, render a selectable user interface (UI) object on the user interface of the administrative console application, the selectable UI object, when selected, configured to execute an action for the installation request, and transmit, over a network, an installation request response to at least one server computer, the installation request response configured to cause a change to a UI control of the application store platform. The installation request includes an application identifier that identifies the application and count information that indicates how many pending installation requests are associated with the application. The executable instructions include instructions that when executed by the at least one processor cause the at least one processor to receive, via an application programming interface, the installation request from the application store platform. The executable instructions include instructions that when executed by the at least one processor cause the at least one processor to transmit, in response to selection of the UI object, a notification to the computing device associated with the organization, the notification indicating whether the installation request is approved or denied. The executable instructions include instructions that when executed by the at least one processor cause the at least one processor to transmit, in response to selection of the UI object, installation data to the computing device associated with the organization, the installation data configured to cause the computing device to initiate installation of the application.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a management system for managing installation of applications on computing devices associated with an organization according to an aspect.

FIG. 1B illustrates an example of a user interface (UI) control of an application store platform according to an aspect.

FIG. 1C illustrates an example of a UI control of an application store platform according to another aspect.

FIG. 1D illustrates an example of a UI control of an application store platform according to another aspect.

FIG. 1E illustrates an example of a UI control of an application store platform according to another aspect.

FIG. 1F illustrates a list of installation requests displayed on a computing device of an administrator according to an aspect.

FIG. 2A illustrates an example user interface depicting information from an application store platform according to an aspect.

FIG. 2B illustrates an example user interface depicting information about a particular application from an application store platform according to an aspect.

FIG. 2C illustrates an example of a UI object informing a user about sending an installation request according to an aspect.

FIG. 2D illustrates an example of a UI control of an application store platform according to another aspect.

FIG. 2E illustrates a list of installation requests rendered on a user interface of a computing device associated with an administrator according to an aspect.

FIG. 2F illustrates an example user interface of a computing device associated with an administrator according to an aspect.

FIG. 2G illustrates an example user interface depicting information from an application store application according to an aspect.

FIG. 2H illustrates an example user interface depicting information from a developer documentation page according to an aspect.

FIG. 2I illustrates an example user interface of a computing device associated with an administrator according to another aspect.

FIG. 2J illustrates an example user interface of a computing device associated with an administrator according to another aspect.

FIG. 2K illustrates an example of a notification displayed on a computing device associated with the organization according to an aspect.

FIG. 2L illustrates an example user interface depicting information from an application store platform according to an aspect.

FIG. 3 illustrates an example user interface of a computing device associated with an administrator according to another aspect.

FIG. 4 illustrates an example of a UI object that can be displayed on a display of a computing device associated with an organization according to an aspect.

FIG. 5 illustrates a management system for managing installation of applications to be installed on computing devices associated with an organization according to an aspect.

FIG. 6 illustrates a flowchart depicting example operations of a management system according to an aspect.

FIG. 7 illustrates a flowchart depicting example operations of a management system according to another aspect.

FIG. 8 shows an example of a computer device and a mobile computer device according to an aspect.

### DETAILED DESCRIPTION

This disclosure relates to a management system that provides a technical solution of enabling a computing device to request installation for an application provided by an application store platform, where the installation request is aggregated with other pending requests for the same application and sent, in real-time (or near real-time), to a computing device associated with an administrator of an organization. For example, if an application request setting is enabled, a UI control of the application store platform is modified (e.g., changed from “install” to “request”). Receipt of a user selection to the modified UI control may cause an installation request to be generated and sent to the computing device associated with the administrator.

The administrator's computing device may display a list of installation requests that are received from the computing devices associated with an organization. Each installation request may identify the requested application and the number of counts (e.g., many times the application has been requested). For each installation request (e.g., of an application store application), the administrator may approve or deny a respective installation request, and a notification is sent to the computing device(s) indicating that installation has been allowed/denied. In some examples, if approved, the management system enables the application store application to modify the UI control to change the UI control to allow installation of the application. In some examples, if approved, the management system can force the application to be installed on the computing device (e.g., automatically installed on the user's computing device). For example, if approved, the application can be automatically installed on the user's computing device (e.g., installed on the user's computing device without user action from the user of the computing device). The technical benefits include an automated application request process in which installation events are transmitted through the management system to the administrator's computing device in real-time and an approval process in which requesting users are automatically notified.

The management system may overcome one or more technical problems associated with interfacing between an application store platform that offers applications for installation and an application management unit that manages the allowability of applications, by implementing a communication protocol between the application store platform and the application management unit in which the UI control(s) of the application store platform can be selectively modified to generate an installation request or permit installation of the application on the computing device.

For example, an application (e.g., a web browser, an application store application, etc.) may render information from an application store platform. In some examples, the user may use a web browser to visit an application store website to search for applications to install. In some examples, the user may launch an application store application on their computing device and search for applications to install. In some examples, the application store platform may use an application programming interface (API) to obtain information about a state condition of an application displayed on the user interface. If the requested application is indicated as not allowed, a UI control may be modified, e.g., changed from providing an option to install the application to an option to request installation of the application. In response to receipt that the user has selected the modified UI control, an installation request is generated and provided to the administrator's computing device for approval/denial. These and other features are further explained with reference to the figures.

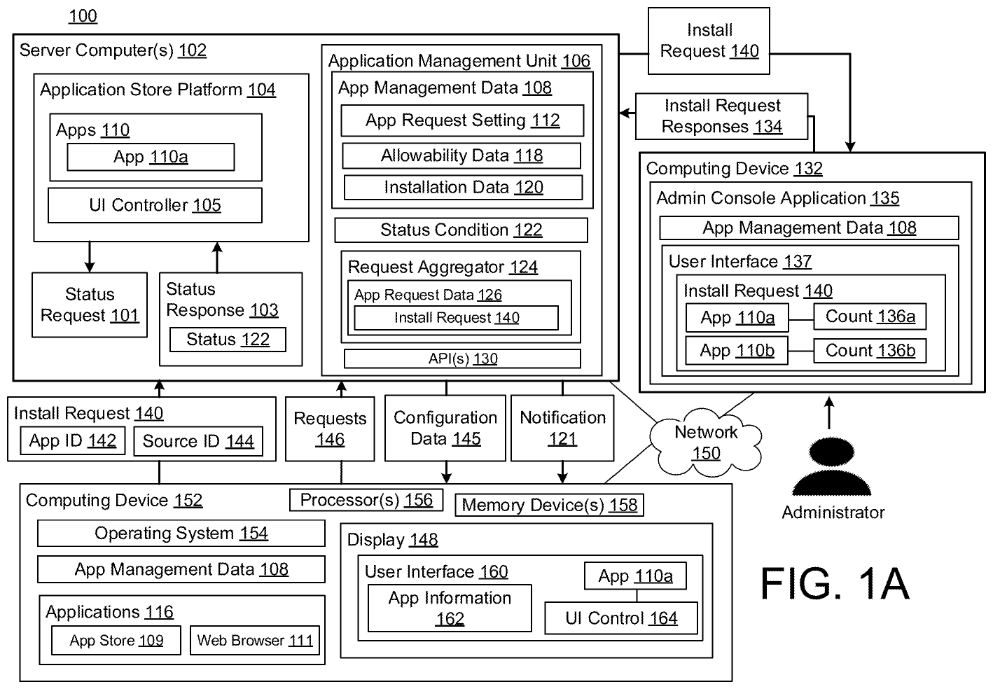

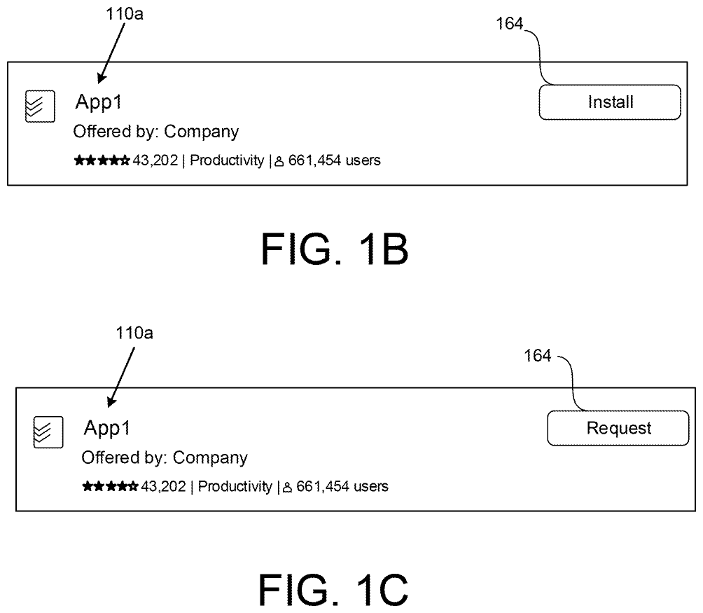

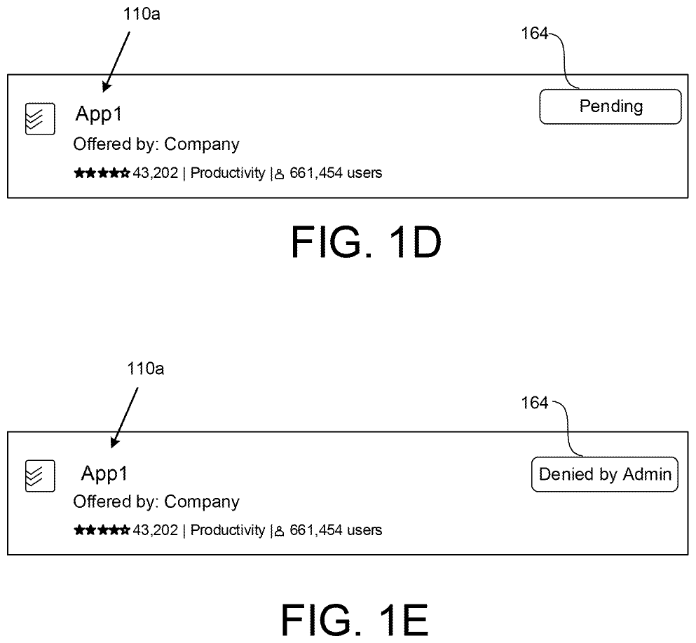

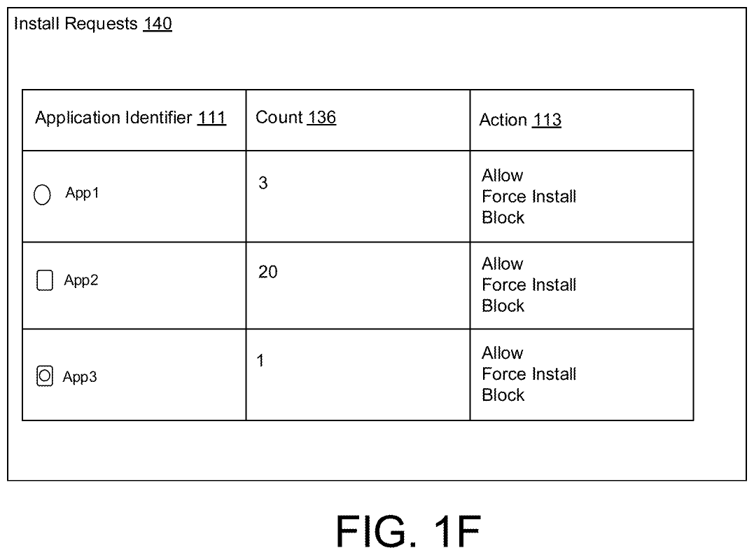

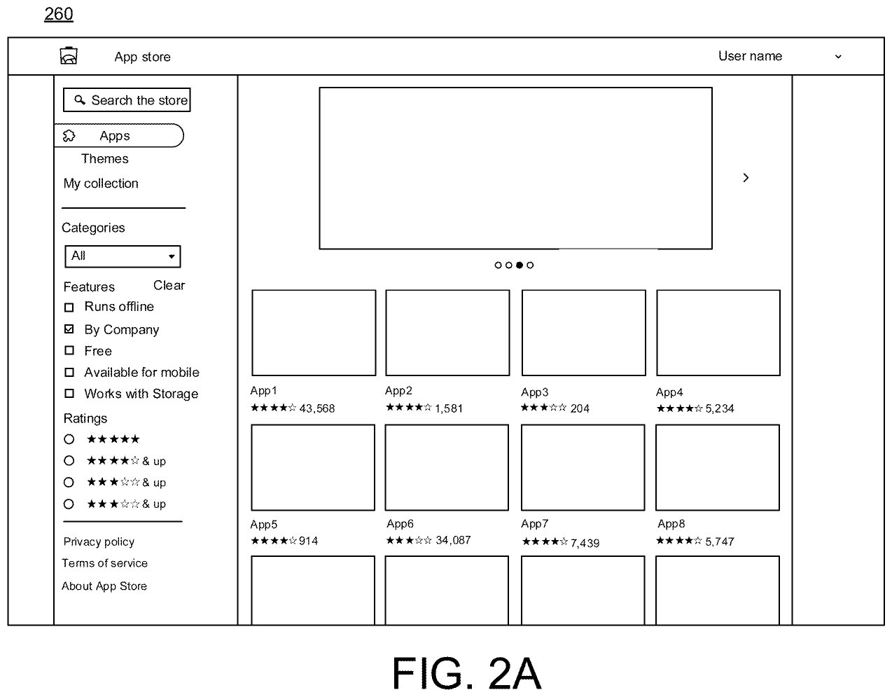

FIGS. 1A through 1F illustrate a management system 100 for managing the installation of applications 110, offered by an application store platform 104, on computing devices 152 associated with an organization.

The management system 100 includes a computing device 132 associated with an administrator of an organization. The computing device 132 includes an administrative console application 135 that provides a user interface 137 to enable an administrator to define application management data 108, which is transmitted to and stored on an application management unit 106 executable by one or more server computers 102. In some examples, the administrative console application 135 is a web application executable (at least in part) by a web browser to render the user interface 137. In some examples, the administrative console application 135 is a native application installed and executed by an operating system of the computing device 132.

The application management data 108 may include an application request setting 112 (which can be enabled or disabled) and allowability data 118 indicating whether certain applications 110 are allowed and/or denied. In some examples, the allowability data 118 may include an allow list that identifies applications 110 allowed by the administrator to be installed on the computing devices 152. In some examples, the allowability data 118 includes a block list that identifies applications 110 that are blocked from being installed on the computing devices 152.

If the application request setting 112 is enabled (e.g., the application request setting 112 has a first value), applications 110, offered by the application store platform 104, can be requested to be installed. If the request is approved, the application 110 is added to the allow list. If the request is denied, the application 110 is added to the block list. If the application request setting 112 is disabled (e.g., the application request setting 112 has a second value), applications 110, offered by the application store platform 104, can be installed on the computing device 152 (without approval from the administrator). In some examples, the application request setting 112 is a browser setting associated with a web browser. In some examples, the application request setting 112 is an operating system setting associated with an operating system 154. In some examples, the application request setting 112 is a setting associated with the application management unit 106 and/or the administrative console application 135.

The application management unit 106 may receive, over a network 150, the application management data 108 from the computing device 132. The application management unit 106 may store the application management data 108 on one or more memory devices associated with the server computer(s) 102. The application management unit 106 may transmit the application management data 108 (or a portion thereof) to computing devices 152 associated with the organization. In some examples, the application management unit 106 may send information indicating enablement of the application request setting 112 to the computing devices 152 associated with the organization. In some examples, the application management unit 106 may identify the device identifiers, browser identifiers, and/or operating system identifiers for users having computing devices 152 associated with the organization, and send information indicating enablement of the application request setting 112 to the appropriate devices, web browsers, and/or operating systems of the computing devices 152.

A computing device 152 may store the application management data 108 (or a portion thereof) in a memory device 158 associated with the computing device 152. For example, the computing device 152 may store the value of the application request setting 112 in the memory device 158. In some examples, the application request setting 112 is a web browser setting and is stored in a memory device 158 associated with the storage of web browser settings. In some examples, the application request setting 112 is an operating system or device setting and stored in a memory device 158 associated with the storage of operating system or device settings. In some examples, the application request setting 112 may be viewable by a user of the computing device 152 via a setting interface.

The computing device 152 may be any type of computing device that includes one or more processors 156, one or more memory devices 158, a display 148, and an operating system 154 configured to execute (or assist with executing) one or more applications 116. The applications 116 may be applications that are already installed on the computing device 152. In some examples, the applications 116 may include an application store application 109 and/or a web browser 111. In some examples, the display 148 is the display of the computing device 152. In some examples, the display 148 may also include one or more external monitors that are connected to the computing device 152. The operating system 154 is a system software that manages computer hardware, software resources, and provides common services for computing programs.

The computing device 152 and the computing device 132 may communicate with the server computer(s) 102 over the network 150. The server computer(s) 102 may include an application store platform 104. In some examples, the application store platform 104 is a website accessible via the web browser 111. In some examples, the application store platform 104 is accessible via an application store application 109 executable by the operating system 154 of the computing device 152. In some examples, the application store application 109 is a web application. In some examples, the application store application 109 is a native application installable on the operating system 154. The application store platform 104 may provide a plurality of applications 110 to users for downloading and/or installation. In some examples, the application store platform 104 is an online digital media rights store that offers applications 110 from a variety of different application developers.

In some examples, the application store platform 104 provides web applications and/or extensions to the web browser 111. In some examples, the applications 110 include web applications. A web application may be an application program that is stored on a remote server (e.g., a web server) and delivered over the network 150 through the web browser 111 (e.g., a browser tab). In some examples, a web application may be a progressive web application, which can be stored (at least in part) on the computing device 152 and used offline.

In some examples, the applications 110 includes mobile applications configured to be installed and executed on a mobile operating system and/or a desktop operating system. In some examples, the applications 110 include more non-web applications (e.g., non-browser applications), which may be programs that are at least partially stored (e.g., stored locally) on the computing device 152 and/or executable by an operating system 154 of the computing device 152. In some examples, the applications 110 are extensions to the web browser 111. An extension (if enabled) adds a feature or function to the web browser 111. In some examples, an extension is a web browser extension. In some examples, an extension may be HTML, CSS, and/or JavaScript based. Some examples of an application store platform 104 may include Chrome web store, play store, Chrome play store, Android play store, Microsoft store, Apple Store, etc.

The application store application 109 and/or the web browser 111 (or other application 116) may communicate with the application store platform 104 in order to discover applications 110 to be downloaded and installed on the computing device 152. For example, the application store application 109 and/or the web browser 111 may render a user interface 160 on the display 148 and render application information 162 from the application store platform 104 on the user interface 160. The application information 162 may provide information about a plurality of applications 110 provided by the application store platform 104. For example, the user can search, filter, and/or scroll through available applications 110 that are available to be installed via the application store platform 104.

A user may manipulate a UI control 164 on the user interface 160 to initiate the installation of an application 110a, which causes the computing device 152 to install the application 110a on the computing device 152. The UI control 164 is a control associated with the application store platform 104. Installation of the application 110a on the computing device 152 may include associating (or attaching) the application 110a (e.g., a web application or extension) to the web browser 111 of the user (or user account) of the web browser 111. In some examples, the associating (or attaching) the application 110a to the web browser, which causes the application 110a to be available to any computing devices 152 associated with a particular user account. In some examples, the application 110a may be installed on the web browser 111. In some examples, installation of the application 110a on the computing device 152 may include downloading the application 110a (or a portion of the application 110a) from a remote server that hosts the application 110a, where the application 110a (or a portion of the application 110a) is installed on the web browser 111 or the operating system 154.

The application store platform 104 may communicate with the application management unit 106 to transmit and receive status requests and status responses 103, respectively, to obtain a status condition 122 of an application 110a identified on the user interface 160. The application store platform 104 may change the UI control 164 on the user interface 160 based on the status condition 122 of the application 110a. In some examples, the application store platform 104 changes an action (or function) of the UI control 164 and/or changes information that is displayed with respect to the UI control 164 based on the status condition 122 of the application 110a.

The application store platform 104 may communicate with the application management unit 106 using one or more application programming interfaces (APIs) 130 to obtain information about the status condition 122. In other words, the application store platform 104 may use the APIs 130 to obtain the status condition 122 of the application 110a. To obtain the status condition 122, the application store platform 104 may transmit a status request 101 to the application management unit 106 via the APIs 130. The status request 101 may identify the application 110a. In response to the status request 101, the application management unit 106 may determine the status condition 122 based on the application request setting 112, the allowability data 118, and/or application request data 126. The application request data 126 includes installation requests 140 that have been previously received.

The status condition 122 of the application 110a may include a first status in which the application request setting 112 is enabled, a second status in which the application request setting 112 is enabled and a pending installation request for the application 110a is stored in the application request data 126, a third status in which the application request setting 112 is enabled and the application 110a is denied (by the administrator), a fourth status in which the application request setting 112 is disabled and the application 110a is on the block list, a fifth status in which the application request setting 112 is enabled and the application 110a is approved (by the administrator), a sixth status in which the application request setting 112 is disabled, and/or a seventh status in which the application 110a is already installed on the computing device 152.

The application store platform 104 may receive a status response 103 that includes the status condition 122 of the application 110a. In some examples, the status response 103 includes an application identifier 142 of the application 110a. In some examples, the status response 103 also includes instructions to modify the UI control 164. In some examples, the instructions to modify the UI control 164 are already stored on the application store platform 104 and the status response 103 includes the status condition 122.

The application store platform 104 may receive requests 146 to display information from the application store platform 104, and, in some examples, the application store platform 104 transits a status request 101 if the requested information includes information about an installation capability of the application 110a. In some examples, the application store platform 104 transmits a status request 101 if the UI control 164 is displayed (or requested to be displayed) on the user interface 160. In some examples, the request 146 includes a user selection to review details about the application 110a.

Based on the status condition 122 included in the status response 103, a UI controller 105 of the application store platform 104 changes the UI control 164 rendered on the user interface 160. For example, the application store platform 104 may transmit configuration data 145 to the computing device 152 (e.g., to the web browser 111 or the application store application 109), where the configuration data 145 is configured to modify the function and/or display of the UI control 164. In some examples, if the status condition 122 is the sixth status (e.g., the application request setting 112 is disabled), the UI control 164 may provide an option to install the application 110a (e.g., “install”, “add to browser”, etc.), as shown in FIG. 1B. Selection of the UI control 164 in FIG. 1B causes installation of the application 110a on the computing device 152. However, if the status condition 122 is the first status (e.g., the application request setting 112 is enabled), in some examples, the UI control 164 may be modified, as shown in FIG. 1C. In some examples, the UI control 164 of FIG. 1C provides an option to request installation of the application 110a. Selection of the UI control 164 in FIG. 1C causes generation of an installation request 140.

Since the UI control 164 is continued to be displayed on the user interface 160, the application store platform 104 may continue to communicate with the application management unit 106 to obtain the status condition 122 of the application 110a. The application management unit 106 may determine that the status condition 122 of the application 110a has changed (e.g., changed to the second status) based on the application request setting 112 and the application request data 126, and return the status condition 122 of the status response 103. Since the status condition 122 of the application 110a has changed (e.g., there is a pending installation request 140), the application store platform 104 may provide new configuration data 145 indicating to change the UI control 164, as shown in FIG. 1D. The UI control 164 of FIG. 1D indicates that the installation request is pending and has deactivated selection of the UI control 164.

If the installation request 140 has been denied, the allowability data 118 is updated to indicate that the application 110a is on the block list. Since the UI control 164 is continued to be displayed on the user interface 160, the application store platform 104 may continue to communicate with the application management unit 106 to obtain the status condition 122 of the application 110a. The application management unit 106 may determine that the status condition 122 of the application 110a is the third status based on the application request setting 112 and the allowability data 118 and return the status condition 122 of the status response 103. Since the status condition 122 of the application 110a has changed (e.g., the installation request 140 is denied), the application store platform 104 may provide new configuration data 145 indicating to change the UI control 164, as shown in FIG. 1E.

In response to selection of the UI control 164 of FIG. 1C, the computing device 152 (e.g., the operating system 154, the application store application 109, or the web browser 111) or the application store platform 104 may generate an installation request 140 to be transmitted to the application store platform 104. In some examples, receipt of the user selection of the UI control 164 of FIG. 1C causes the generation of an installation request 140 (also can be referred to as a request event or install request event). In some examples, the application store platform 104 generates the installation request 140 in response to the detection of the user selection of the UI control 164 of FIG. 1C. The installation request 140 may include an application identifier 142 of the application 110a and a source identifier 144 that identifies a source of the installation request 140. In some examples, the source identifier 144 includes a user identifier of the computing device 152, the web browser 111, or the operating system 154.

The application store platform 104 may provide the installation request 140 to the application management unit 106. In some examples, the application store platform 104 uses the API(s) 130 to transfer the installation request 140 to the application management unit 106. In some examples, the computing device 152 (e.g., the operating system 154, the web browser 111, or the operating system 154) uses the APIs(s) 130 to transmit the installation request 140 to the application management unit 106. In some examples, the API(s) 130 include a single API. In some examples, the APIs 130 include two or more APIs. In some examples, a first API is used by the application store platform 104 to obtain the status condition 122 of applications 110, and a second API is used by the application store platform 104, the operating system 154, the application store application 109, or the web browser 111 to transmit the installation request 140.

The application management unit 106 may receive the installation request 140 for the application 110a and store the installation request 140 on a memory device associated with the server computer(s) 102. In some examples, the application management unit 106 includes a request aggregator 124 that stores and updates application request data 126. The application request data 126 may include the installation requests 140 that have been generated by the management system 100. In some examples, the installation requests 140 include the installation requests 140 that are currently pending. Each installation request 140 may identify an application identifier 142, a source identifier 144, and time information indicating a date/time that a respective installation request 140 was generated. In some examples, the request aggregator 124 may aggregate installation requests 140 for a particular organization or organization unit within an organization. For example, the application request data 126 may include a first pending installation request for the application 110a, a second pending installation request for the same application 110a, and a third pending installation request for the same application 110a. The first, second, and third pending installation requests may be from different source identifiers 144. The request aggregator 124 may aggregate the installation requests 140 for the same requested application 110a so that the user interface 137 of the administrative console application 135 identifies the application 110a (once) with a count 136a of the pending installation request 140 (e.g., three installation requests 140).

The administrative console application 135 may communicate with the application management unit 106 to provide the application request data 126 on the user interface 137 of the administrative console application 135. For example, the administrative console application 135 may receive, over the network 150, the installation requests 140 from the application management unit 106 executable on the server computer(s) 102. As shown with respect to FIGS. 1A and 1F, the user interface 137 may display the installation requests 140. For example, the administrative console application 135 may render a list of the (pending) installation requests 140, where each installation request 140 identifies a requested application 110 along with a count that indicates the number of installation requests 140 received for the respective application 110. For example, the user interface 137 may identify application 110a along with a count 136a, e.g., how many times the application 110a has been requested, and may identify application 110b along with a count 136b, e.g., how many times the application 110b has been requested.

As shown in FIG. 1F, for each installation request 140 identified on the user interface 137, the administrative console application 135 may provide an option to an action 113 for a corresponding installation request 140. Referring to FIG. 1A, in response to receipt of a selected action 113, the administrative console application 135 is configured to transmit, over the network 150, an install request response 134 to the application management unit 106. The install request response 134 is configured to change the UI control 164 associated with the application store platform 104. In some examples, the UI control 164 is changed to the UI control 164 of FIG. 1B, which allows the user to select the UI control 164 to initiate installation of the application 110a.

The action 113 may include allow, force install, or block. For example, in response to the selection of an action 113, the computing device 132 may transmit an install request response 134 that identifies an application identifier 142 of the application 110, the source identifier(s) 144, and the selected action 113. If the selected action 113 indicates to allow the application 110a, the UI control 164 is changed to the UI control 164 of FIG. 1B, which allows the user to select the UI control 164 to initiate installation of the application 110a. In some examples, if the selected action 113 indicates to allow the application 110a, the application management unit 106 may update the allowability data 118 (e.g., add the application 110a to the allow list). In some examples, the application management unit 106 may transmit a notification 121 to the source identifier(s) 144 identified in the install request response 134 to notify the user(s) that the application 110a has been approved. In some examples, the notification 121 is a message displayed on a display 148 of the computing device 152. In some examples, the notification 121 is an email to an email account associated with the source identifier(s) 144. In some examples, the notification 121 is a message that is displayed in one of the applications 116.

If the selected action 113 is denied, the application management unit 106 may update the allowability data 118 (e.g., add the application 110a to the block list). In some examples, the application management unit 106 may transmit a notification 121 to the source identifier(s) 144 identified in the install request response 134 to notify the user(s) that the application 110a has been denied. In some examples, the UI control 164 is changed to the UI control 164 of FIG. 1E, which deactivates selection of the UI control 164 and displays information that indicates that the application 110a has been denied.

If the selected action 113 is force install, the application management unit 106 may generate or update installation data 120 that identifies the application 110a and the source identifier(s) 144. The application management unit 106 may transmit the installation data 120 to the computing devices 152 identified by the source identifiers 144, which, when received at a respective computing device 152, causes the computing device 152 to automatically install the application 110a. In some examples, the application management unit 106 may transmit a notification 121 to the source identifier(s) 144 identified in the install request response 134 to notify the user(s) that the application 110a has been installed or will be installed.

The computing device 152 may be any type of computing device that includes one or more processors 156, one or more memory devices 158, a display 148, and an operating system 154 configured to execute (or assist with executing) one or more applications 142. In some examples, the computing device 152 is a laptop or desktop computer. In some examples, the computing device 152 is a tablet computer. In some examples, the computing device 152 is a smartphone. In some examples, the computing device 152 is a wearable device. The display 148 is the display of the computing device 152. The display 148 may also include one or more external monitors that are connected to the computing device 152.

The operating system 154 is a system software that manages computer hardware, software resources, and provides common services for computing programs. In some examples, the operating system 154 is an operating system designed for a larger display 148 such as a laptop or desktop (e.g., sometimes referred to as a desktop operating system). In some examples, the operating system 154 is an operating system for a smaller display 148 such as a tablet or a smartphone (e.g., sometimes referred to as a mobile operating system).

The processor(s) 156 may be formed in a substrate configured to execute one or more machine executable instructions or pieces of software, firmware, or a combination thereof. The processor(s) 156 can be semiconductor-based—that is, the processors can include semiconductor material that can perform digital logic. The memory device(s) 158 may include a main memory that stores information in a format that can be read and/or executed by the processor(s) 156. The memory device(s) 158 may store the application management data 108 and applications (e.g., the operating system 154, applications 116, etc.) that, when executed by the processors 156, perform certain operations.

The computing device 132 may be an example of the computing device 152 and may include any of the features discussed with reference to the computing device 152. For example, the computing device 132 may be a laptop or a desktop computer. In some examples, the computing device 132 may be a tablet or a smartphone. The computing device 132 may include one or more processors and one or more memory devices. In some examples, the computing device 132 is associated with an administrator of an organization. For example, the administrator may be associated with an organization that owns or manages the computing device 152. For example, the computing device 152 (and the computing device 132) may be an enterprise-owned computing device such as a work computer owned or managed by the user's company or a school computer owned or managed by the user's school.

The computing device 152 (and the computing device 132) may communicate with the server computer(s) 102 over the network 150. The server computer 102 may be computing devices that take the form of a number of different devices, for example a standard server, a group of such servers, or a rack server system. In some examples, the server computer(s) 102 may be a single system sharing components such as processors and memories. In some examples, the server computer(s) 102 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. Network 150 may further include any number of hardwired and/or wireless connections.

The server computer(s) 102 may include one or more processors formed in a substrate, an operating system (not shown) and one or more memory devices. The memory devices may represent any kind of (or multiple kinds of) memory (e.g., RAM, flash, cache, disk, tape, etc.). In some examples (not shown), the memory devices may include external storage, e.g., memory physically remote from but accessible by the server computer(s) 102. The server computer(s) 102 may include one or more modules or engines representing specially programmed software.

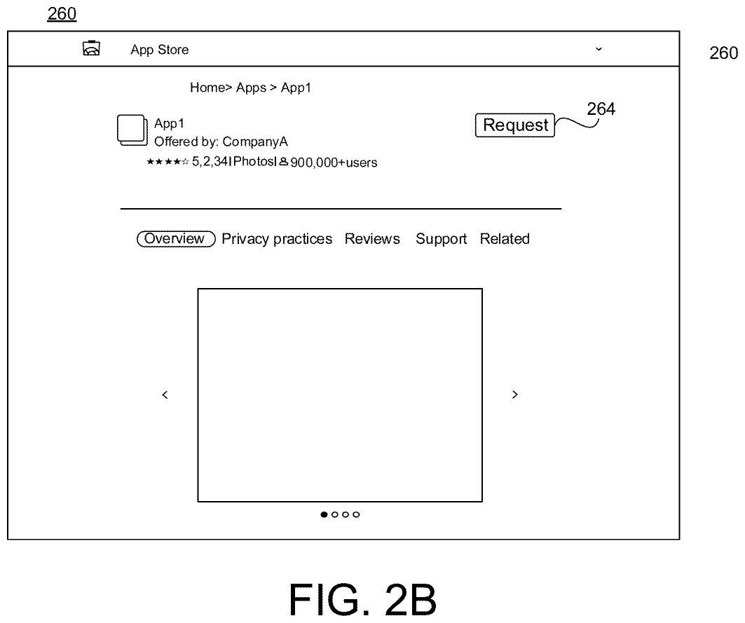

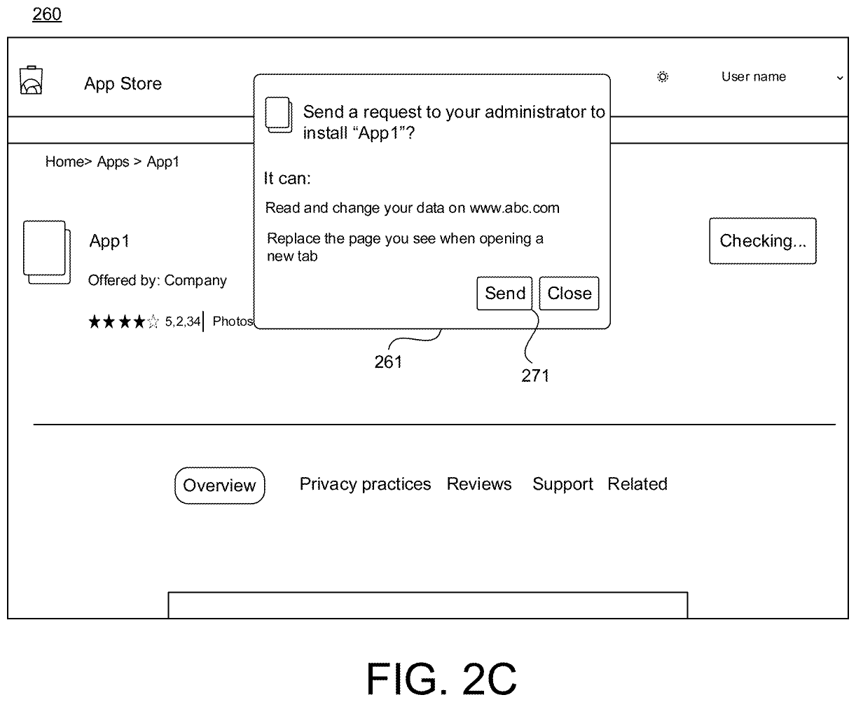

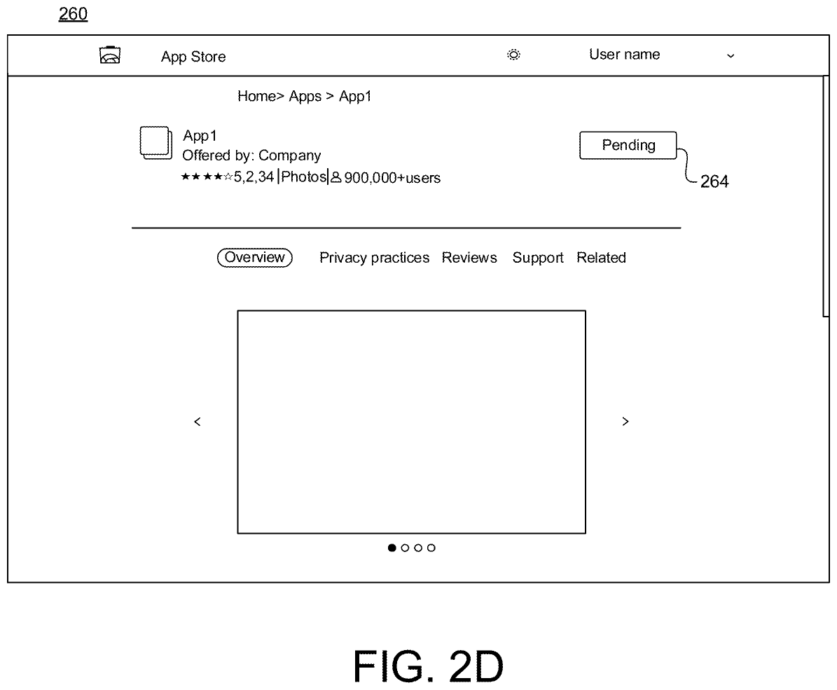

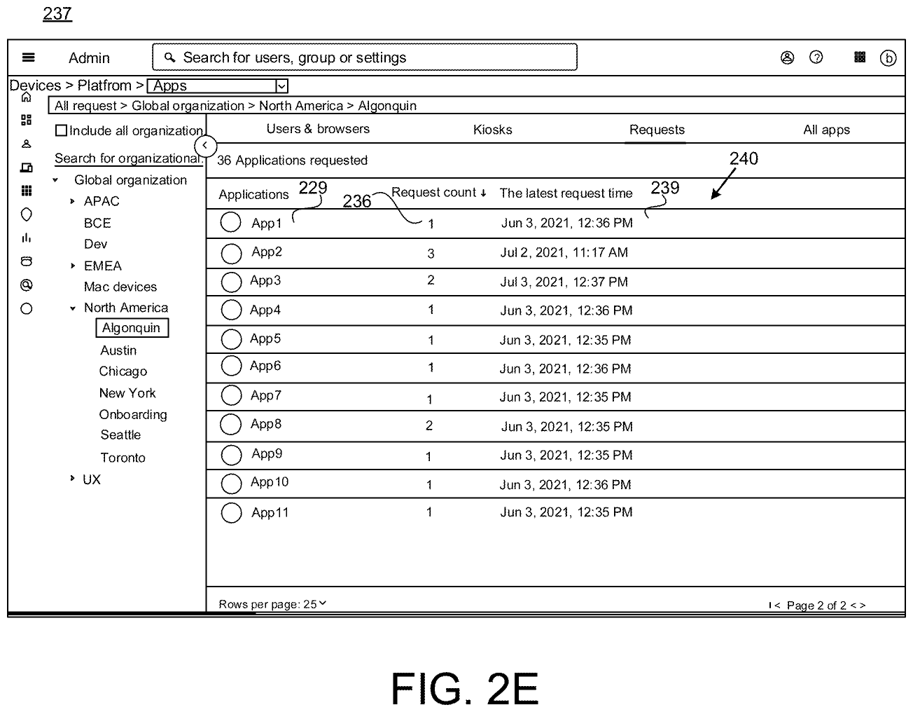

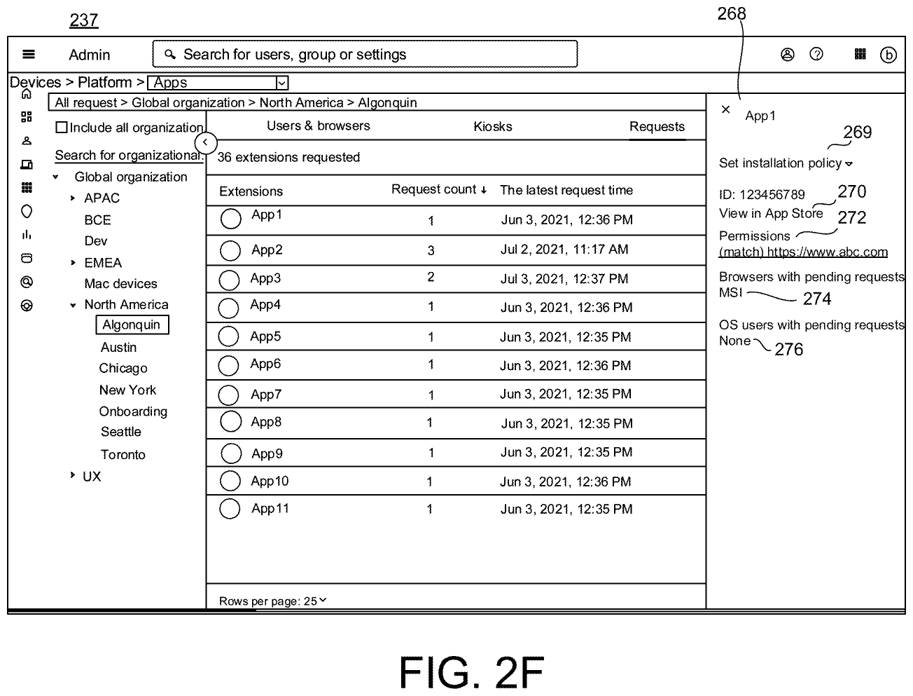

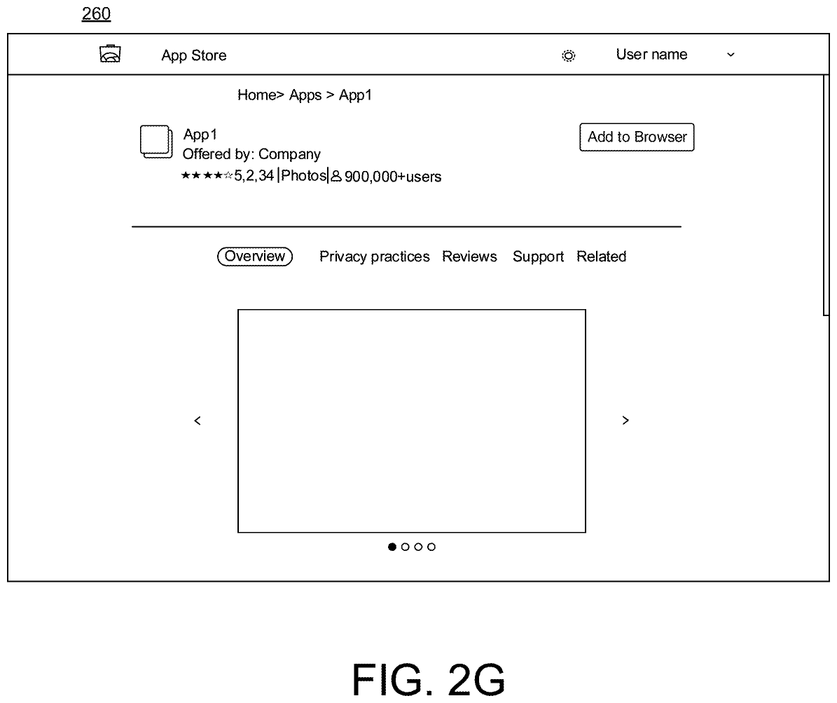

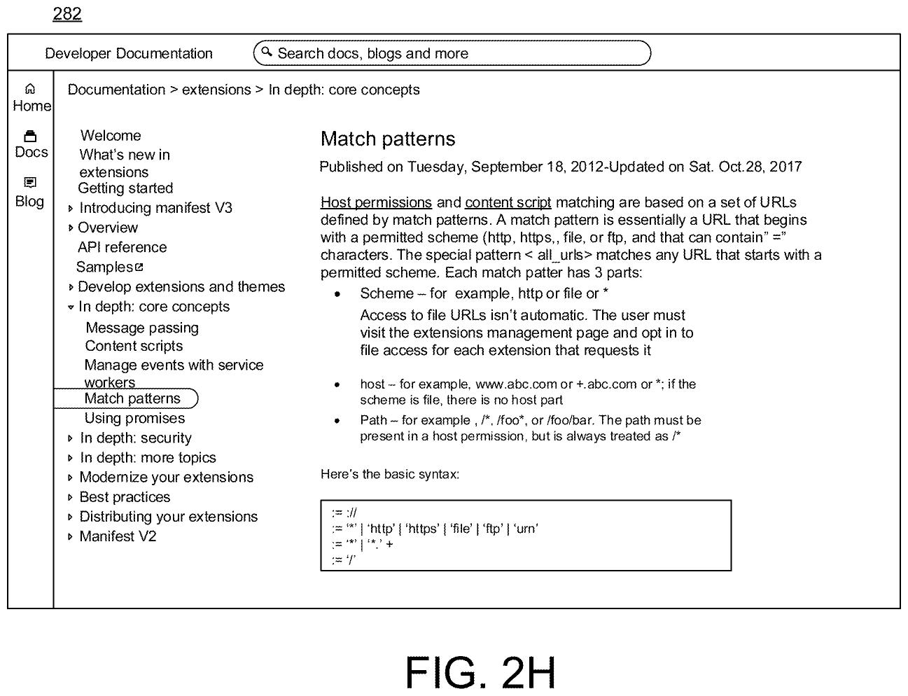

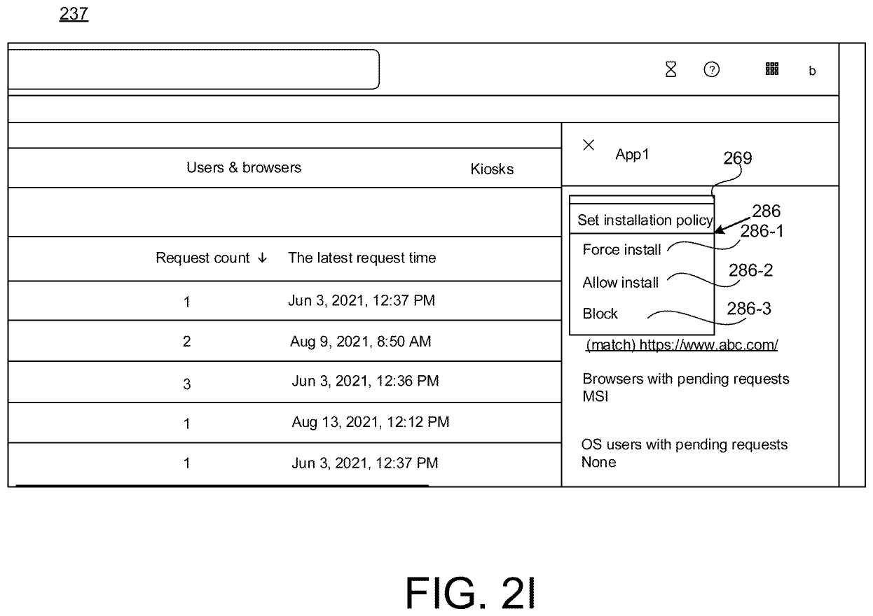

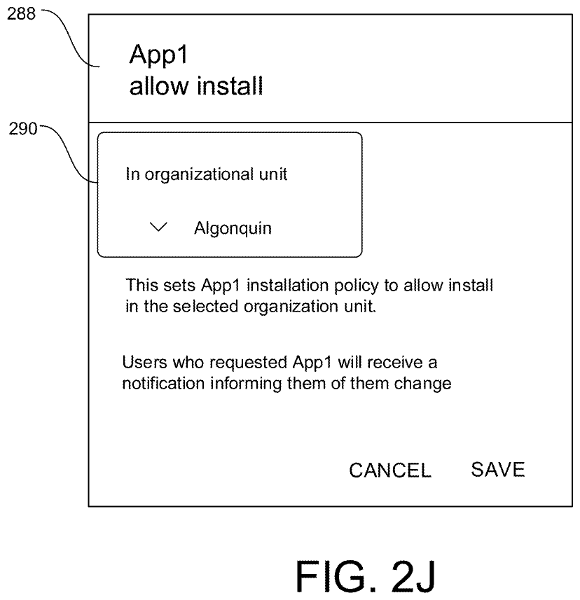

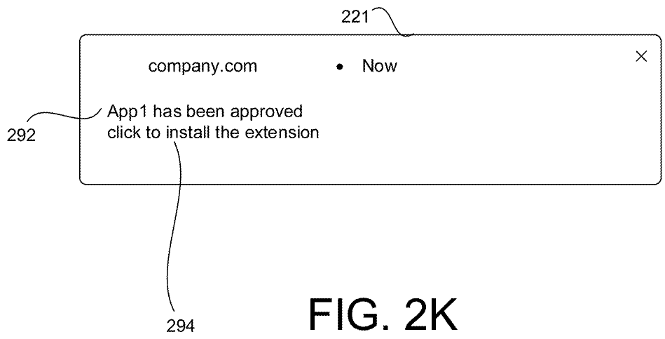

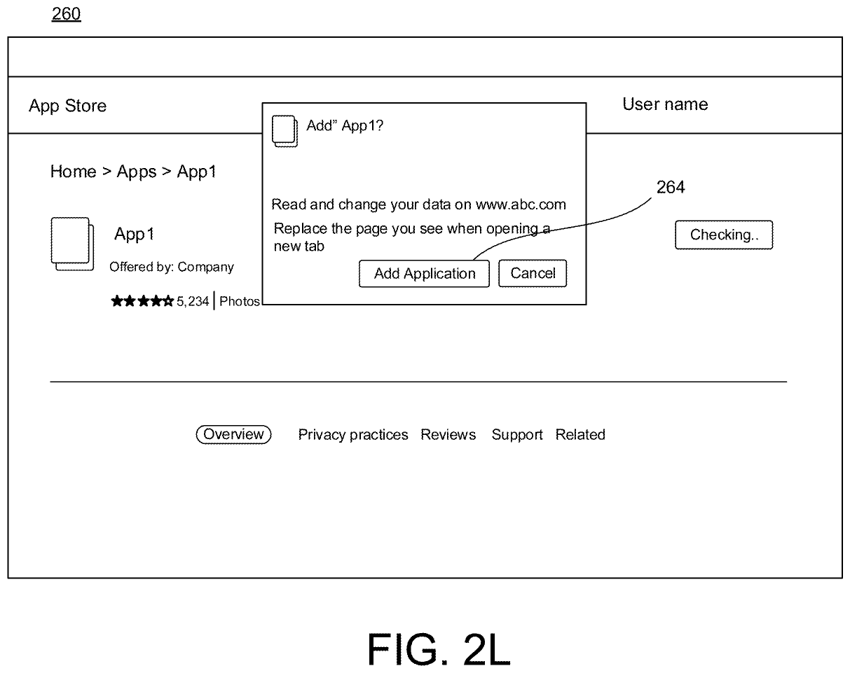

FIGS. 2A through 2L illustrate example screenshots of user interfaces according to aspects. The user interfaces of FIGS. 2A through 2L may be provided by the computing devices of FIGS. 1A through 1F. The description of FIGS. 2A through 2L may include references to the components of FIGS. 1A through 1F.

FIG. 2A illustrates an example of a user interface 260. In some examples, the user interface 260 of a user interface of an application 116. In some examples, the user interface 260 is a user interface of the application store application 109. In some examples, the user interface 260 is a user interface of the web browser 111. As shown in FIG. 2A, a user may search through a plurality of applications (e.g., the applications 110 of FIGS. 1A through 1F) provided by the application store platform 104. In some examples, the user may select an application (App1) (e.g., application 110a of FIGS. 1A through 1F) to obtain additional details about App1, which may cause the user interface 260 of FIG. 2B to be rendered in the web browser.

In response to the selection of App1 on the FIG. 2A, the application store platform 104 may detect a request 146 to obtain additional information, which causes the application store platform 104 to communicate with the application management unit 106 to obtain the status condition 122 of App1. The status condition 122 may indicate that the application request setting 112 is enabled and App1 is not on the allow list of the allowability data 118. The application store platform 104 provides configuration data 145 to change a UI control 264 of the application store platform 104. As shown on FIG. 2B, the UI control 264 displays “request.”

In response to selection of the UI control 264, referring to FIG. 2C, the application 116 generates a confirmation dialog 261 along with information about which information App1 can access and/or which features App1 can execute. In response to selection of a UI control 271 (e.g., “send”), the application 116 an installation request 140 is generated, which is provided to the application management unit 106 via the APIs 130.

Referring to FIG. 2D, the application 116 may render an application details page (which includes the UI control 264), but the UI control 264 of FIG. 2D has changed with respect to FIG. 2B. For example, the application store platform 104 may detect a request 146 to obtain additional information, which causes the application store platform 104 to communicate with the application management unit 106 to obtain an updated status condition 122 of App1. The updated status condition 122 may indicate that the application request setting 112 is enabled and an installation request 140 is currently pending for App1. The application store platform 104 provides new configuration data 145 to change the UI control 264. As shown on FIG. 2B, the UI control 264 displays “pending” and the UI control 264 cannot be selected.

FIG. 2E illustrates an example of a user interface 237 of administrative console application 135 executing on a computing device 132. As shown in FIG. 2E, the user interface 237 provides a list of installation requests 240. Each installation request 240 includes identifier information 229 that identifies a particular application that is requested to be installed, a requested count 236 (e.g., how many installation requests have been received for a respective application), and time information 239 that indicates a time/date of the latest installation request 240 for a respective application. In some examples, the identifier information 229 includes an icon that represents a respective application.

A user may be able to select a particular installation request 240 on the user interface 237 of FIG. 2E. In response to the selection of App1, referring to FIG. 2F, the user interface 237 may display a UI object 268 with more information about App1. For example, referring to FIG. 2F, the UI object 268 may include a selectable UI element 269 that permits the administrator to take an action with respect to App1 (e.g., approve, deny, force install, etc.), a selectable link 270 to view additional information about App1 in the application store platform, a selectable link 272 to view additional information about permissions associated with App1, a selectable link 274 to view which browsers users have requested App1, and a selectable link 276 to view which operating system users have requested App1.

In response to receipt of a selection to the selectable link 270, referring to FIG. 2G, the application 116 may render information from the application store platform 104 that includes the details of App1. In response to receipt of a selection to the selectable link 272, referring to FIG. 2H, the application 116 may render a developer documentation website 282 that provides developer information about the permissions of App1. In response to receipt of a section to the selectable UI element 269, in referring to FIG. 2I, the UI element 269 may provide a plurality of actions 286 for the installation request 140. The actions 286 may include a first action 286-1 (e.g., force install), a second action 286-2 (e.g., allow install), and a third action 286-3 (e.g., block). In response to receipt of a selection to the second action 286-2, referring to FIG. 2J, the application 116 may render a UI object 288 that allows the selection of an organization unit 290, whose members are allowed to install App1.

In some examples, in response to receipt of a selection to the second action 286-2, referring to FIG. 2K, a notification 221 may be displayed on the display 148 of computing device 152. The notification 221 may include information 292 that indicates that App1 has been approved. In some examples, the notification 221 may include a selectable link 294 to install App1. For example, in response to receipt of the selectable link 294, the application 116 may render information from the application store platform that identifies App1 along with the UI control 264, which has been modified to allow the user to install App1.

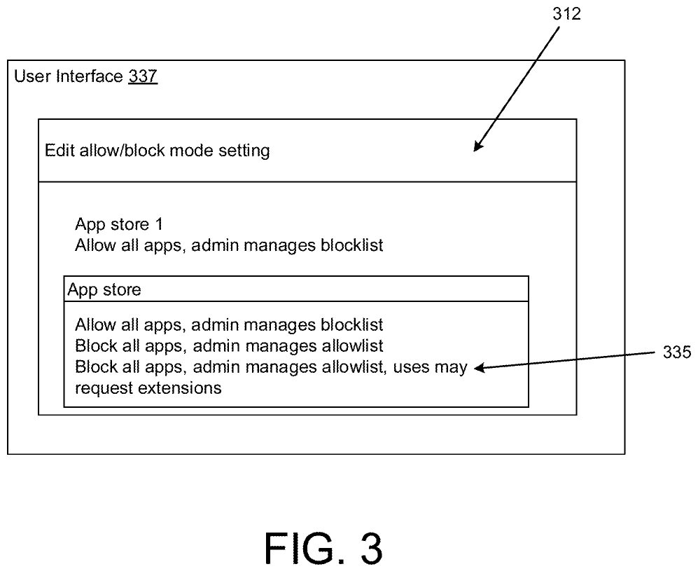

FIG. 3 illustrates a user interface 337 of an administrative console application executable by a computing device of an administrator. In some examples, the administrative console application is a web application executable by a web browser of the computing device. The user interface 337 may allow the administrator to enable/disable an application request setting 312. In some examples, the administrator may enable/disable an application request setting 312 for more than one application store platform, e.g., a first application store platform, a second application store platform, and so forth. In some examples, the applications are considered browser extensions (e.g., extensions to a web browser). In some examples, installation (or adding) the browser extensions are requested using the management system 100 of FIGS. 1A through 1F. In some examples, an administrator may select an installation policy 335, where applications (e.g., applications installable on the device's operating system) are blocked from being installed (unless on an allow list), but browser extensions (installable on a web browser) may be requested.

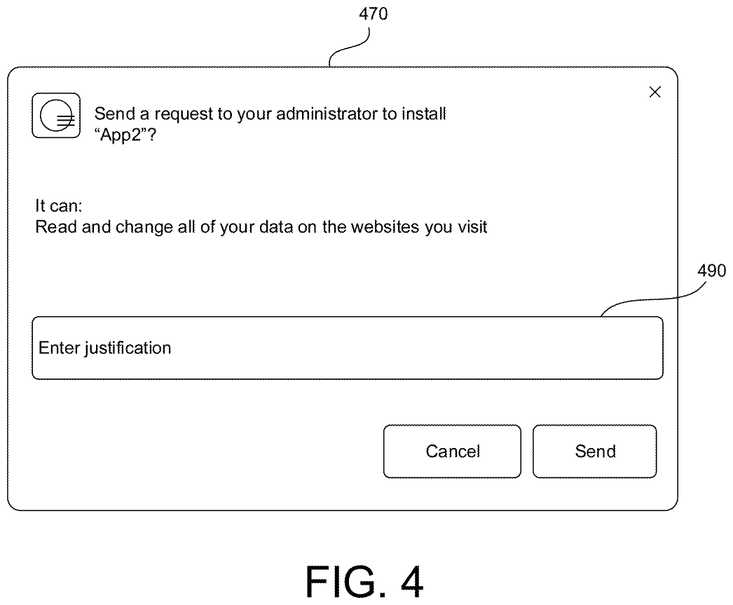

FIG. 4 illustrates an example of a UI object 470 that can be rendered on a user interface of an application store platform. For example, the UI object 470 may be a confirmation dialog that is rendered before sending an installation request (e.g., the installation request 140 of FIGS. 1A through 1F). The UI object 470 may include a text-entry field 490 that allows a user to enter a reason/justification for the request. The text-entry field may be included as part of the installation request 140 that is rendered on the interface 137 of the administrative console application 135.

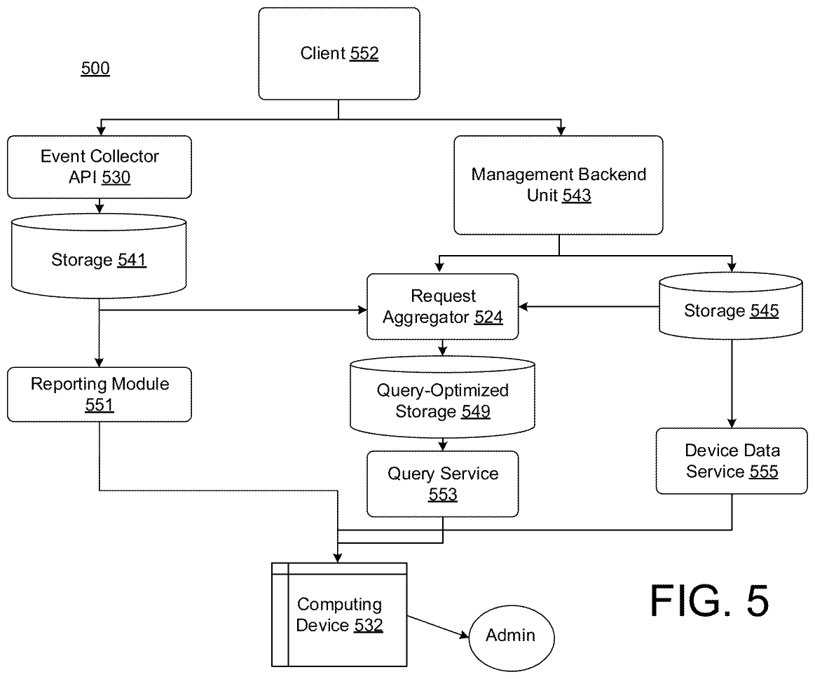

FIG. 5 illustrates a management system 500 according to another aspect. The management system 500 may be an example of the management system 100 of FIGS. 1A through 1F and may include any of the details discussed with reference to those figures. A client 552 may generate an installation request when a user selects a UI control (e.g., the UI control 164 of FIGS. 1A through 1F) to request installation of an application. The installation requests may be provided in real-time (or near real-time) to a computing device 532 associated with an administrator. The client 552 may be a web browser executing on a computing device or an operating system of the computing device. In some examples, the client 552 may be an application store application. In some examples, the client 552 may be a web application. An event collector API 530 may receive the generated installation request. The installation requests are stored in a storage 541. A request aggregator 524 may obtain the installation requests from the storage 541. The request aggregator 524 may aggregate installation requests associated with the same application. The request aggregator 524 may also group and aggregate the installation requests corresponding to a particular organization or organization unit within the organization. The aggregated installation requests are stored in a query-optimized storage 549. Based on commands received from the computing device 532, a query service 553 may query the query-optimized storage 549 to retrieve the aggregated installation requests for display on the computing device 532.

In some examples, a reporting module 551 may generate one or more reports based on the installation requests stored in the storage 541 and the report(s) may be provided to the computing device 532. A management backend unit 543 may obtain information about a web browser or operating system. The management backend unit 543 may periodically obtain the information about a web browser or operating system such as once per day, once per week, multiple times per day, multiple times per week, etc. The information about the web browser or the operating system may include identification of a version of the web browser or operating system, which applications are installed, which applications have been requested, what plug-ins are installed, and/or policies (and/or settings) are configured on the web browser or operating system.

The request aggregator 524 may use the information from the management backend unit 543 to update the aggregated installation requests in the query-optimized storage 549. For example, the information about the web browser or the operation system may include information that indicates a first application has been installed. If the query-optimized storage 549 includes an installation request for the first application, the request aggregator may remove the installation request from the query-optimized storage 549. The information from the management backend unit 543 may be stored in a storage 545. A device data service 555 may retrieve information from the storage 545 and provide the information to the computing device 532.

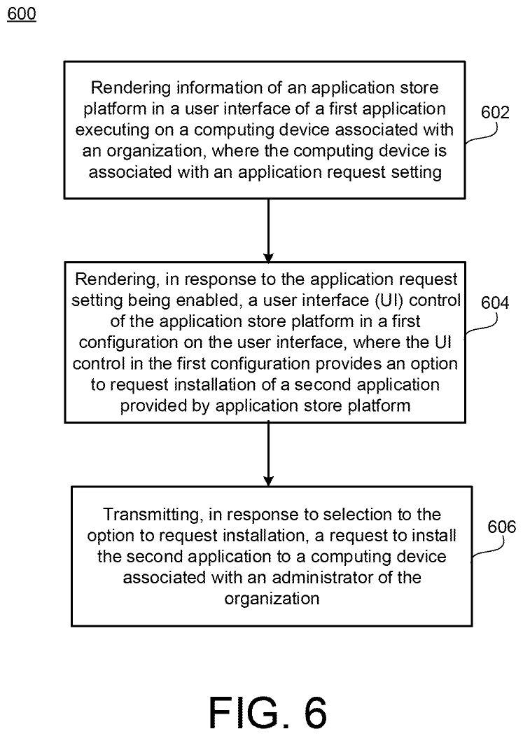

FIG. 6 is a flowchart 600 depicting example operations of a computing device according to an aspect. Although the flowchart 600 is explained with respect to the management system 100 of FIGS. 1A through 1F, the flowchart 600 may be applicable to any of the implementations discussed herein. Although the flowchart 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion.

The operations of the flowchart 600 relate to requesting installation requests using a UI control of an application store platform. In some examples, the operations of the flowchart 600 are executed by one or more components of the management system 100.

Operation 602 includes rendering information of an application store platform 104 in a user interface 160 of a first application (e.g., application 116) executing on a computing device 152 associated with an organization, where the computing device 152 is associated with an application request setting 112. Operation 604 includes rendering, in response to the application request setting 112 being enabled, a UI control 164 of the application store platform 104 in a first configuration on the user interface 160, where the UI control 164 in the first configuration provides an option to request installation of an application 110a. Operation 606 includes transmitting, in response to selection to the option to request installation, a request to install the application (e.g., installation request 140) to a computing device 132 associated with an administrator of the organization.

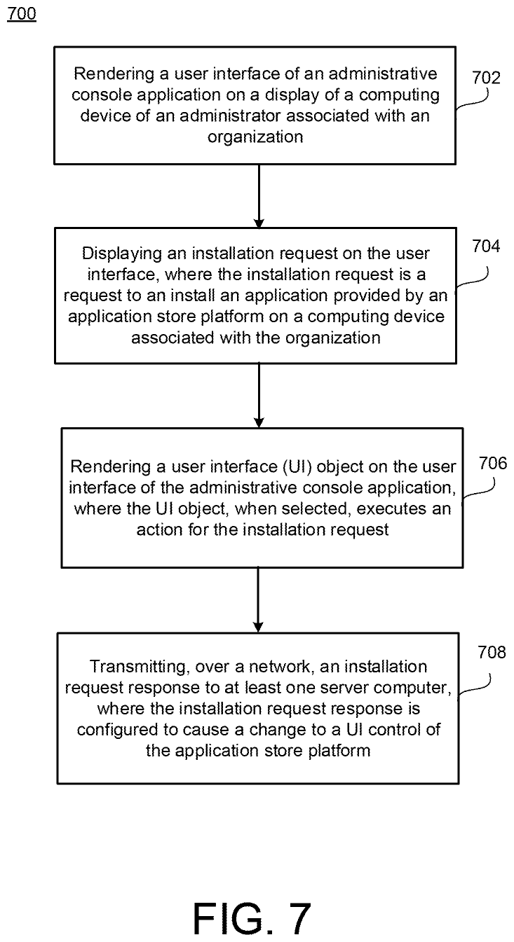

FIG. 7 is a flowchart 700 depicting example operations of a computing device according to an aspect. Although the flowchart 700 is explained with respect to the management system 100 of FIGS. 1A through 1F, the flowchart 700 may be applicable to any of the embodiments discussed herein. Although the flowchart 700 of FIG. 7 illustrates the operations in sequential order, it will be appreciated that this is merely an example, and that additional or alternative operations may be included. Further, operations of FIG. 7 and related operations may be executed in a different order than that shown, or in a parallel or overlapping fashion.

The operations of the flowchart 700 relate to rendering, displaying, and/or causing an action to be taken with response to an installation request. In some examples, the operations of the flowchart 700 are executed by one or more components of management system 100.

Operation 702 includes rendering a user interface 137 of an administrative console application 135 on a display of a computing device 132 of an administrator associated with an organization. Operation 704 includes displaying an installation request 140 on the user interface 137, where the installation request 140 is a request to install an application 110a provided by an application store platform 104 on a computing device 152 associated with the organization. Operation 706 includes rendering a user interface (UI) object on the user interface 137 of the administrative console application 135, where the UI object, when selected, executes an action for the installation request 140. Operation 708 includes transmitting, over a network 150, an install request response 134 to at least one server computer 102, where the install request response 134 is configured to cause a change to a UI control 164 of the application store platform 104.

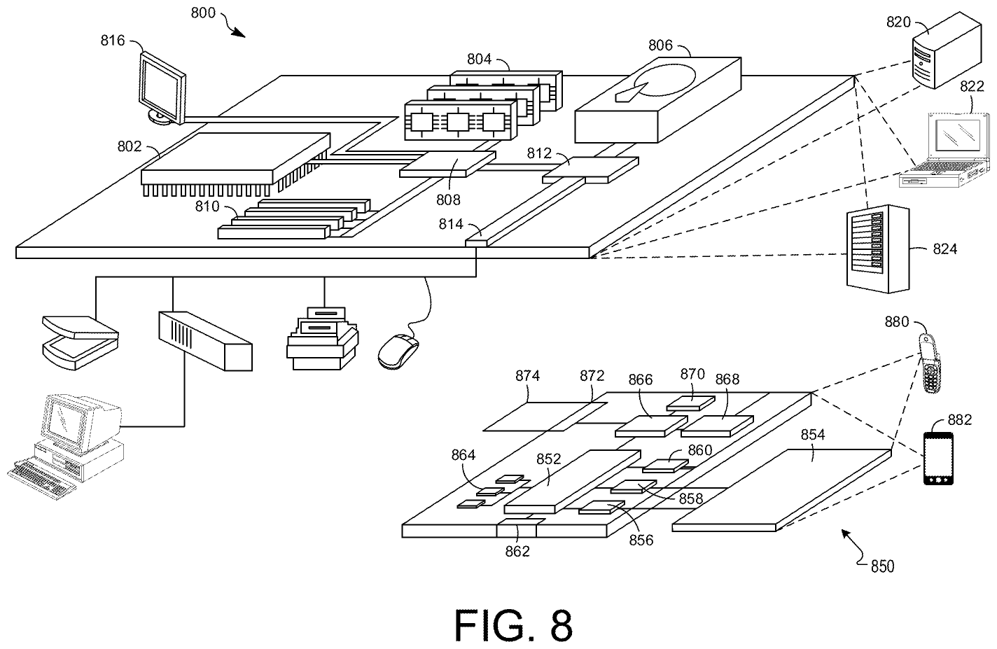

FIG. 8 shows an example of a computing device 800 and a mobile computing device 850, which may be used with the techniques described here. In some implementations, the computing device 152 of FIGS. 1A through 1F is an example of the computing device 800 or the mobile computing device 850. Computing device 800 is intended to represent various forms of digital computers, such as laptops, desktops, tablets, workstations, personal digital assistants, televisions, servers, blade servers, mainframes, and other appropriate computing devices. Computing device 850 is intended to represent various forms of mobile devices, such as personal digital assistants, cellular telephones, smartphones, and other similar computing devices. The components shown here, their connections and relationships, and their functions, are meant to be exemples only, and are not meant to limit implementations described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. The processor 802 can be a semiconductor-based processor. The memory 804 can be a semiconductor-based memory. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions are examples only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more computing devices 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850 or may also store applications or other information for device 850. Specifically, expansion memory 874 may include instructions to carry out or supplement the processes described above and may include secure information also. Thus, for example, expansion memory 874 may be provided as a security module for device 850 and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852 that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, Wi-Fi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or another similar mobile device.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

What is claimed is:

1. A method for requesting installation of applications, the method comprising:
rendering information of an application store platform in a user interface (UI) of a first application executing on a computing device associated with an organization;
rendering a UI control of the application store platform on the user interface, the UI control providing an option to request installation of a second application provided by the application store platform; and
transmitting, in response to selection of the option to request installation, a request to install the second application to a computing device associated with an administrator of the organization.

2. The method of claim 1, further comprising:
determining a status condition of the second application; and
modifying the UI control based on the status condition.

3. The method of claim 2, wherein modifying the UI control includes changing at least one of an action of the UI control or information displayed by the UI control.

4. The method of claim 2, wherein the modified UI control provides an option to initiate installation of the second application, the method further comprising:
initiating, in response to selection of the option to initiate installation, installation of the second application on the computing device associated with the organization.

5. The method of claim 2, wherein the modified UI control provides information that indicates that the request to install the second application is denied.

6. The method of claim 2, wherein the modified UI control provides information that indicates that the request to install the second application is pending.

7. The method of claim 1, further comprising:
receiving configuration data for the UI control; and
modifying the UI control according to the configuration data.

8. The method of claim 1, further comprising:
storing application management data for managing the computing device associated with the organization, the application management data including an application request setting.

9. The method of claim 8, further comprising:
rendering, in response to the application request setting being enabled, the UI control in a first configuration, the UI control in the first configuration providing the option to request installation of the second application; and
rendering, in response to the application request setting being disabled, the UI control in a second configuration, the UI control in the second configuration provides an option to initiate installation of the second application on the computing device associated with the organization.

10. The method of claim 1, further comprising:
rendering a notification on a display of the computing device associated with the organization, the notification indicating whether the request to install the second application is approved or denied.

11. The method of claim 1, wherein the first application is a web browser.

12. The method of claim 1, wherein the first application is an application store application executable by an operating system of the computing device associated with the organization.

13. An apparatus comprising:
at least one processor; and
a non-transitory computer-readable medium storing executable instructions that when executed by the at least one processor cause the at least one processor to:
render information of an application store platform in a user interface of a first application executing on a computing device associated with an organization, the computing device being associated with an application request setting;
render, in response to the application request setting being enabled, a user interface (UI) control of the application store platform in a first configuration on the user interface, the UI control in the first configuration providing an option to request installation of a second application provided by the application store platform; and
transmit, in response to selection of the option to request installation, a request to install the second application to a computing device associated with an administrator of the organization.

14. The apparatus of claim 13, wherein the executable instructions include instructions that when executed by the at least one processor cause the at least one processor to:
render, in response to the application request setting being disabled, the UI control in a second configuration, the UI control in the second configuration providing an option to initiate installation of the second application on the computing device associated with the computing device.

15. The apparatus of claim 13, wherein the executable instructions include instructions that when executed by the at least one processor cause the at least one processor to:
render, in response to the application request setting being enabled, the UI control in a second configuration, the UI control in the second configuration displaying information that indicates that the request to install the second application is denied.

16. The apparatus of claim 13, wherein the executable instructions include instructions that when executed by the at least one processor cause the at least one processor to:
render, in response to the application request setting being enabled, the UI control in a second configuration, the UI control in the second configuration displaying information that indicates that the request to install the second application is pending.

17. The apparatus of claim 13, wherein the executable instructions include instructions that when executed by the at least one processor cause the at least one processor to:
receive installation data in response to the request to install being approved, the installation data configured to cause the computing device associated with the organization to install the second application.

18. The apparatus of claim 13, wherein the executable instructions include instructions that when executed by the at least one processor cause the at least one processor to:
receive configuration data for the UI control; and
render the UI control in the first configuration according to the configuration data.

19. The apparatus of claim 13, wherein the second application is an extension to the first application.

20. The apparatus of claim 13, wherein the first application is an application store application.

21. A non-transitory computer-readable medium storing executable instructions that when executed by at least one processor cause the at least one processor to execute operations, the operations comprising:
rendering information of an application store platform in a user interface of a web browser executing on a computing device associated with an organization;
rendering a UI control of the application store platform on the user interface, the UI control providing an option to request installation of an application provided by the application store platform; and
transmitting, in response to selection of the option to request installation, a request to install the application to a computing device associated with an administrator of the organization.

22. The non-transitory computer-readable medium of claim 21, wherein the operations further comprise:
storing application management data for managing the computing device associated with the organization, the application management data including an application request setting associated with the web browser;
rendering, in response to the application request setting being enabled, the UI control in a first configuration, the UI control in the first configuration providing the option to request installation of the application; and
rendering, in response to the application request setting being disabled, the UI control in a second configuration, the UI control in the second configuration providing an option to initiate installation of the application on the computing device associated with the organization.

23. The non-transitory computer-readable medium of claim 21, wherein the operations further comprise:
detecting a request to display the information of the application store platform;
receiving configuration data for the UI control; and
modifying the UI control according to the configuration data.

24. The non-transitory computer-readable medium of claim 21, wherein the request to install the application includes an application identifier of the application and a source identifier that identifies a source of the request to install the application.

25. The non-transitory computer-readable medium of claim 21, wherein the application is a web application executable by the web browser.

26. An apparatus comprising:
at least one processor; and
a non-transitory computer-readable medium storing executable instructions that when executed by the at least one processor cause the at least one processor to:
render a user interface of an administrative console application on a display of a computing device of an administrator associated with an organization;
display an installation request on the user interface, the installation request being a request to install an application provided by an application store platform on a computing device associated with the organization;
render a selectable user interface (UI) object on the user interface of the administrative console application, the selectable UI object, when selected, configured to execute an action for the installation request; and
transmit, over a network, an installation request response to at least one server computer, the installation request response configured to cause a change to a UI control of the application store platform.

27. The apparatus of claim 26, wherein the installation request includes an application identifier that identifies the application and count information that indicates how many pending installation requests are associated with the application.

28. The apparatus of claim 26, wherein the executable instructions include instructions that when executed by the at least one processor cause the at least one processor to:
receive, via an application programming interface, the installation request from the application store platform.

29. The apparatus of claim 26, wherein the executable instructions include instructions that when executed by the at least one processor cause the at least one processor to:
transmit, in response to selection of the UI object, a notification to the computing device associated with the organization, the notification indicating whether the installation request is approved or denied.

30. The apparatus of claim 26, wherein the executable instructions include instructions that when executed by the at least one processor cause the at least one processor to:
transmit, in response to selection of the UI object, installation data to the computing device associated with the organization, the installation data configured to cause the computing device to initiate installation of the application.
